(19) United States
(12) Patent Application Publication
(10) Pub. No.: US 2009/0003388 A1
(43) Pub. Date: Jan. 1, 2009

(54) METHOD AND APPARATUS FOR SYNCHRONIZING PORTED NUMBER DATA

(75) Inventors: Cynthia Florkey, Fort Collins, CO (US); Ruth Schaefer Gayde, Naperville, IL (US); John Richard Rosenberg, Elmhurst, IL (US)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES, INC., Murray Hill, NJ (US)

(21) Appl. No.: 11/772,125

(22) Filed: Jun. 30, 2007

(51) Int. Cl. H04J 3/06

(52) U.S. Cl. 370/503

(57) ABSTRACT

A method of synchronizing ported number data within a telecommunications network in which a number portability administration center has received a request from a subscriber having a directory number (DN) to port is provided. The method comprises the steps of: a Number Portability data manager sending a subscription request to the NPDB to receive future notifications about subscriber ports to/from specific Location Routing Number(s); the NPDB honoring these subscriptions when a user ports their DN. If this is the initial LRN assigned to the DN, then the NPDB derives the LRN of the code holder. If the LRN from which the subscriber ported has a subscription, then the NPDB sends a notification message to the NP data manager with which the LRN is associated indicating that the DN ported out. If the LRN to which the subscriber ported has a subscription, then the NPDB sends a notification message to the NP data manager with which the LRN is associated indicating that the DN ported in. The method further comprises receiving a notification message for the LRN at a number portability data manager, wherein: if the notification message indicates that a DN has ported in, then the number portability data manager sends a request to an ENUM (telephone number mapping) server to turn the entry for that DN on; and if the notification message indicates that a DN has ported out, then the number portability data manager sends requests to the ENUM server and to a subscriber database to turn the entry for that DN off.

### BACKGROUND OF THE INVENTION

This invention relates to a method and apparatus for synchronizing ported number data between the existing number portability infrastructure and IMS networks. While the invention is particularly directed to the art of telecommunications, and will be thus described with specific reference thereto, it will be appreciated that the invention may have usefulness in other fields and applications.

By way of background, there is an existing number portability (NP) infrastructure allowing people to port between technologies and service providers, which works well for circuit-world-to-circuit-world porting. Since number portability is here to stay with respect to both old and new networks, it is necessary to efficiently handle number portability in both types of networks.

The distributed nature of data in next-generation networks adds additional complexity when trying to coordinate information that changes due to a subscriber porting from one network to another. A mechanism for staging and synchronizing the activation and deactivation of this data would be useful to the service provider. The problem is that one realm is not ready to “say GO” when the other realm is ready. Specifically, it would be advantageous to pre-provision data in the receiving network and have a mechanism that can turn the new data on in the new network at the same time as turning off the old data in the old network. Since the two networks are not integrated, such synchronization is not currently available and consequently a call from within the new network (where the data is pre-populated but not turned on yet) may not receive consistent or appropriate routing.

Some examples of prior art call flows involving number portability in wireless networks are shown in FIGS. 1-2. These examples relate to IMS (IP Multimedia Subsystem) networks. IMS is well known in the art. See, for example, U.S. Pub. No. 2005/0096029, the disclosures of which are incorporated by reference herein.

FIG. 1 shows a call flow for a normal IMS call between A and B. Initially, A calls B, whereby the call origination is received by A's S-CSCF (Serving-Call Session Control Function) 10. A's S-CSCF 10 then queries an ENUM (Telephone Number Mapping) server 12 for B's routing information (including the directory number (DN) for B). The ENUM server 12 sends a response to A's S-CSCF 10 (including the routing information for the call). A's S-CSCF 10 then sends an ENUM entry to an I-CSCF (Interrogating-CSCF) 14. The I-CSCF 14 obtains B's location from an HSS (Home Subscriber Server) 16. Finally, the call is routed to B's S-CSCF 18.

FIG. 2 shows a call flow for an IMS call between A and B. But in this case, B is “sported in” per the NPDB 20, but not yet updated in the ENUM server 12. Initially, A calls B, whereby the call origination is received by A's S-CSCF 10. A's S-CSCF 10 then queries the ENUM server 12 for B. In this example, there is no entry for B. The ENUM server 12 then sends a response to A's S-CSCF 10 indicating that there is no ENUM entry for B. A's S-CSCF 10 routes the call to the BGCF 22. The BGCF 22 then routes the call to the MGCF 24. The MGCF 24 sends a number portability query regarding B to the NPDB 20. If the port is in effect, then B's LRN is obtained and the call is routed back to the IMS network. In that case, the MGCF 24 routes the call to the I-CSCF 14, which obtains B's S-CSCF from the HSS 16 (which has already been updated to add B's pending subscriber information) and routes the call to B's S-CSCF 18, which may result in unpredictable behavior due to no ENUM entry.

Similar data coordination issues exist for the ported out case which can also lead to mis-handled calls. Thus, the prior art call flows are quite complex and may lead to misrouted calls.

The present invention contemplates a new and improved method and apparatus for synchronizing between the current NP infrastructure and next-generation networks that resolves the above-referenced difficulties and others.

### SUMMARY OF THE INVENTION

A method and apparatus for synchronizing between the current NP infrastructure and next-generation networks to increase efficiency in the network and assure appropriate call routing are provided.

In one aspect of the invention a method of synchronizing ported number data within a telecommunications network in which a number portability administration center has received a request from a subscriber having a directory number (DN) to port is provided. The method comprises the steps of:
An NP data manager subscribing to changes in network-level NP data for the LRNs that switch/network owns.
NP databases (NPDB) honoring those subscriptions and providing notifications when a number is ported into or out of an LRN to which some switch/network NP data manager has subscribed.
The NPDB determining to which NP data managers to send this notification for both ported into and ported out from networks.
   If this is the first time this DN has ever been ported, the NPDB deriving the code holder based on the DN and informing the NP Data manager associated with that code holder that this DN is porting out.
   For non-first-time ports, the NPDB deriving (via the LRN in its internal database associated with this DN) the NP data manager for the ‘old’ network and informing that NP data manager this DN is ported out. Also, the NPDB using the new LRN to derive the NP data manager for the ‘new’ network and informing the NP data manager that this DN is ported in.
The NP data manager, on receiving a notification, activating or deactivating local NP data for the number which has ported in or ported out in the ENUM and/or ENUM/HSS.

In another aspect of the invention, an apparatus for synchronizing ported number data within a telecommunications network in which a number portability administration center has received a request from a subscriber having a Directory Number (DN) to port is provided. The apparatus comprises:
A new NP data manager within a system serving end users, which subscribes to changes in network-level NP data for the LRNs that switch/network owns. On receiving a notification, the NP data manager activates or deactivates local NP data for the Number which has ported in or ported out in the ENUM and/or ENUM/HSS.
A new capability inside existing network NP databases (NPDB) which honors those subscriptions and, using the methods described above, provides notifications when a number is ported into or out of an LRN to which some switch/network NP data manager has subscribed.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which like reference numerals represent like elements and wherein:

FIG. 1 illustrates a call flow for a normal IMS call between A and B;

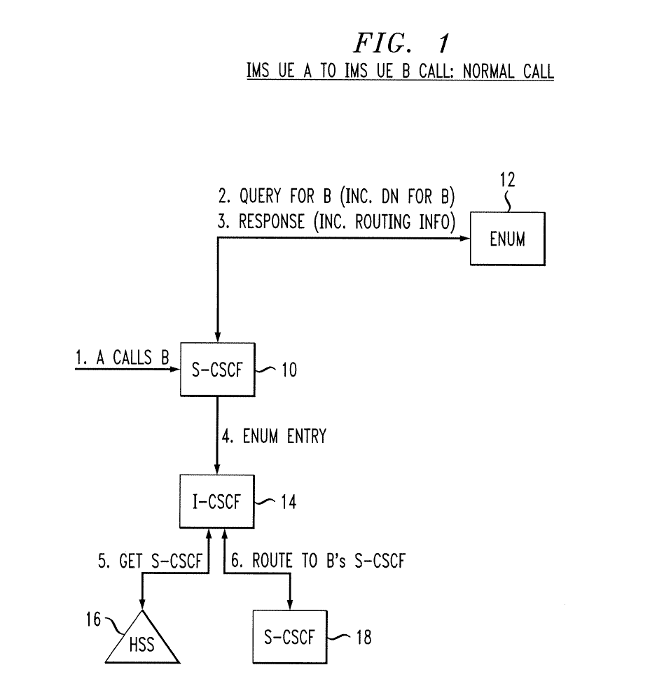

FIG. 2 is a call flow for an IMS call between A and B where B is “ported in” per the NPDB, but not yet updated in the ENUM server;

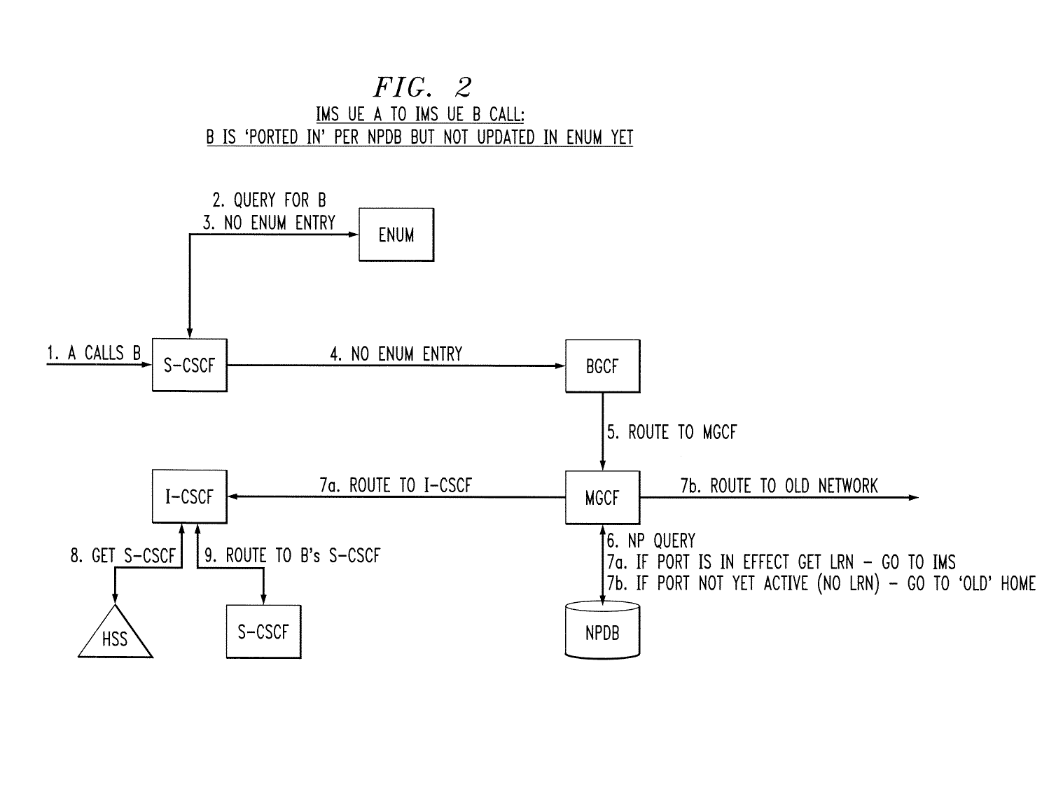

FIG. 3 illustrates an exemplary telecommunications network suitable for implementing aspects of the present invention; and

FIG. 4 illustrates a sample call flow for an IMS call between callers A and B according to aspects of the present invention.

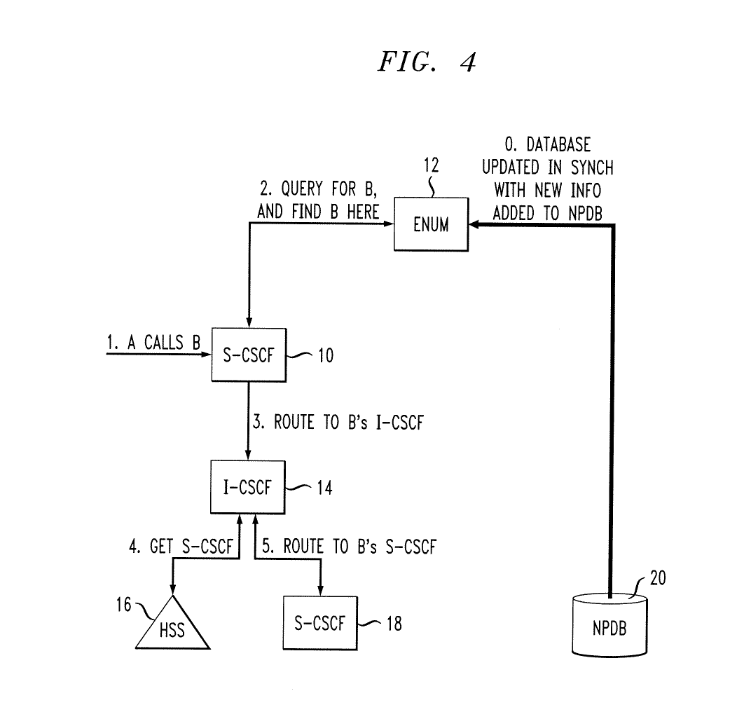

### DETAILED DESCRIPTION

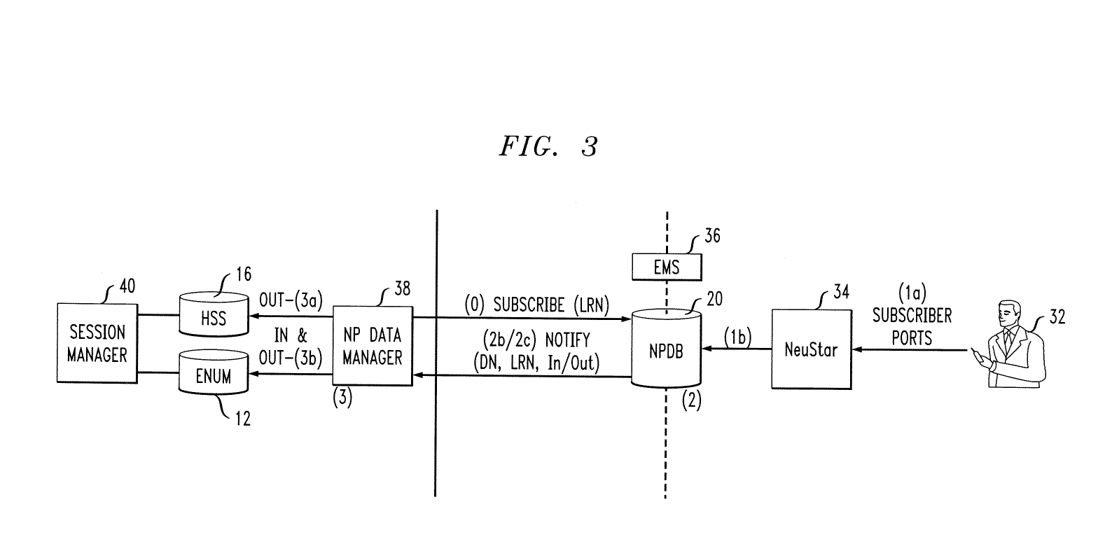

Referring now to the drawings wherein the showings are for purposes of illustrating the exemplary embodiments only and not for purposes of limiting the claimed subject matter, FIG. 3 provides a view of a telecommunications network 30 suitable for implementing aspects of the present invention. The telecommunications network 30 may provide users with a variety of options for communication. Users are generally able to transmit and receive multimedia communications, including audio, voice, video, and all types of data. The telecommunications network 30 provides access to data networks, such as the Internet, and public telephone networks, including wireless networks. It is to be understood, however, that other such networks may be suitable for implementing aspects of the present invention. Thus, while this discussion features elements present in certain telecommunication systems, such as an IMS, the invention is not intended to be limited to the examples discussed. That is, the exemplary method would work with other types of networks as well, including, for example, an IP network, a wireless network (CDMA, IDEN, WiFi, WIMAX, UMTS, GSM, etc.), or the PSTN (public switched telephone network), just to name a few.

The telecommunications network 30 generally includes: a subscriber 32, a number portability management service such as NeuStar 34, an optional element management system (EMS) 36, the number portability database (NPDB) 20, a number portability (NP) data manager 38, the ENUM server 12, a subscriber database such as the HSS 16, a session manager 40, and signaling between these elements.

The subscriber 32 is a user whose service can be ported from an old network and to a new network, maintaining the same directory number. Either or both of these networks may be an IMS network. The subscriber may be using any type of end user device, e.g. wired, cellular, WiFi.

In the United States, NeuStar, Inc. acts as a data manager and keeps track of inter-carrier ported telephone numbers. Thus, number portability data may be stored in a NeuStar Number Portability Administration Center (NPAC) database 34, wherein the number portability data may identify if a number is ported and the facilities to which the number is ported.

The EMS 36 manages one or more of a specific type of network elements. An EMS allows the service provider to manage all the features of each network element individually, but not the communication between the network elements—this is done by the network management system. Network elements expose one or more management interfaces that the EMS uses to communicate with and to manage them. These management interfaces use a variety of protocols including SNMP, TL1, CLI, XML, and CORBA.

The NPDB 20 may be accessed by a switching element, such as a mobile switching center (MSC) (not shown), to provide the LRN value for the ported DN (Directory Number) in order to correctly route the call. The NPDB 20 contains the applicable number portability information transmitted from the NPAC (Number Portability Administration Center) Service Management System to the service provider's Local Service Management System. Each service provider will either own or have access to an NPDB 20 that will contain the mapping between the MDN and the LRN.

The NPDB 20 contains the routing information necessary to support number portability. More particularly, the NPDB 20 provides the association between the called party and the LRN (location routing number) identifying the switch to which the call should now be routed. The NPDB 20 stores all ported numbers within the ported domain. A Ported Number is a Directory Number (DN) that has been ported—or moved—from one service provider to another or from one switch to another within the same service provider network.

The NP data manager 38 may reside, for example, within the next generation call control environment. It subscribes to NP data updates occurring on the network-based NPDB 20 which involve subscribers that are porting into or out of the next generation call control environment. When informed of such updates, the NP data manager 38 synchronizes local subscription data (e.g., ENUM server, HSS) to be consistent with the NP data in the network 30.

ENUM (Telephone Number Mapping) is a suite of protocols to unify the telephone numbering system E.164 with the Internet addressing system DNS (Domain Name System) by using an indirect lookup method, to obtain NAPTR (Naming Authority Pointer) records. The records are stored at a DNS database. The ENUM server 12 stores an NAPTR resource record specifying a number which identifies a call being conducted among IP communication devices and specifying identification data for an IP communication device that attends the telephone conference. The ENUM server 12 also transmits a corresponding NAPTR resource record in response to a query from an IP communication device.

The HSS 16 includes subscriber profile information, including information similar to that which is traditionally associated with a home location register (HLR) for a mobile subscriber. Suitably, the HSS 16 stores information such as user identification, user security information, including network access control information for authentication and authorization, user location information for user registration and locating, and user profiles, including identification of the services subscribed to and other service specific information.

The session manager 40 manages individual call sessions participating in the network 30.

The signaling between the above NP-related elements is used to establish subscriptions and receive updates about relevant subscribers. These updates include inbound and outbound NP ports.

The network elements described above are generally functions that may reside in one or more processor-based devices. These devices execute programs to implement the functionality described herein and generally associated with 3GPP/3GPP2 wireless systems. These devices may be specially constructed for the required purposes, or they may comprise one or more general-purpose computers selectively activated or reconfigured by one or more computer programs stored in the computer(s). Such computer program(s) may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The flexibility of these processor-based systems permits ready integration into these systems of a method for synchronizing ported number data in accordance with the present invention. It should be noted, however, that as utilized herein, the term “processor” is not intended to refer exclusively to hardware capable of executing software.

With continued reference to FIG. 3, an exemplary method of synchronizing ported number data is described below:

0. As an initial step, the NP data manager 38 sends a subscription request to the NPDB 20 to receive future notifications about subscriber ports to/from specific Location Routing Number(s). A next generation system could contain one or more NP data managers, and all would make such subscription requests to the NPDB for the appropriate LRNs.

1a. Next, the subscriber contacts the new service provider to port their number to them. The new service provider informs the old service provider and NeuStar about the port. However, the NP data manager 38 does not find out about this until step 3 below. The subscriber's directory number (DN) is assigned a new or updated LRN as a result of the subscriber's porting request.

1b. The NeuStar database 34 then passes this porting information directly to the NDPB 20. In an alternative embodiment, this information could come to the NPDB 20 through the EMS 36 instead of directly from the NDPB 20. In this alternative embodiment, the subscription and notification can be handled by the EMS 36 rather than the NPDB 20 itself without loss of functionality.

2. Next, the NPDB 20 updates its database, using prior art methods. Further, the NPDB 20 is enhanced to perform several additional steps with this invention.

2a. If this is the initial LRN assigned to the DN (i.e., a first-time port), then the NPDB 20 derives the LRN of the code holder. That is, this LRN points to the switch to which this NPA-NXX range is natively assigned (i.e., before number portability).

2b. If the LRN from which the subscriber 32 ported (the old LRN) has a subscription, then the NPDB 20 sends a notification message (e.g., a SIP NOTIFY message) to the switch to which the LRN is associated indicating that the DN ported out.

2c. If the LRN to which the subscriber 32 ported (the new LRN) has a subscription, then the NPDB 108 sends a notification message indicating that the DN ported in.

3. Finally, the NP data manager 38 receives the notification message for an LRN of interest.

3a. If the notification message indicates that a DN has ported in, the NP data manager 38 will send a request to the ENUM server 12 to turn the entry for that DN “on”.

3b. If the notification message indicates that a DN has ported out, the NP data manager 38 will send requests to the ENUM server 12 and to the HSS 16 to turn the entry for that DN “off”.

A sample call flow for an IMS call between callers A and B is shown in FIG. 5. In this example, B is “ported out” per the NPDB 20, and B's status is updated in the ENUM server 12.

0. Initially, since B has been “ported in” to the NPDB 20, this information is transmitted to the ENUM server 12. Thus, the NPDB 20 is synchronized with the ENUM server 12.

1. Now, A calls B, whereby the call is received by A's S-CSCF 10.

2. A's S-CSCF 10 queries the ENUM server 12 for B. B is subsequently found in the ENUM server 12 since it has been synchronized with the NPDB 20.

3. The S-CSCF 10 routes the call to B's l-CSCF 14.

4. The I-CSCF 14 obtains B's S-CSCF 18 from the HSS 16.

5. The call is then routed to B's S-CSCF 18.

In summary, the invention is focused on the addition of an NP Data manager to a network, which subscribes to changes in network-level NP data for the LRNs that switch/network owns. It further involves a new capability inside existing network NP Databases (NPDB), which honors those subscriptions and provides notifications when a number is ported into or out of an LRN to which some switch/network NP data manager has subscribed.

Included in this capability is a means for the NPDB to determine which network to send this to (both for ported in, and ported out). For a first time port, the NPDB needs to derive the code holder based on the DN and informs the NP Data manager associated with that code holder that this DN is porting out. For other ports, the NPDB needs to derive (via the LRN in its internal database associated with this DN) the NP data manager for the “old” network and inform that NP data manager this DN is ported out. Also, the NPDB will use the new LRN to derive the NP data manager for the “new” network and inform that NP data manager that this DN is ported in.

Further capabilities in the NP data manager include, upon receiving a notification, activating or deactivating local NP data for the Number which has ported in or ported out in the ENUM and/or ENUM/HSS.

Some portions of the description below have been presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of synchronizing ported number data within a telecommunications network in which a number portability administration center has received a request from a subscriber having a directory number (DN) to port, the method comprising the steps of:
an NP data manager subscribing to changes in network-level NP data for the LRNs that switch/network owns;
a plurality of NP databases (NPDB) honoring those subscriptions and providing notifications when a number is ported into or out of an LRN to which some switch/network NP data manager has subscribed;
the NPDB determining to which NP data managers to send this notification for both ported into and ported out from networks;
if this is the first time this DN has ever been ported, the NPDB deriving the code holder based on the DN and informing the NP Data manager associated with that code holder that this DN is porting out;
for non-first-time ports, the NPDB deriving (via the LRN in its internal database associated with this DN) the NP data manager for the ‘old’ network and informing that NP data manager this DN is ported out. Also, the NPDB using the new LRN to derive the NP data manager for the ‘new’ network and informing the NP data manager that this DN is ported in;
the NP data manager, on receiving a notification, activating or deactivating local NP data for the Number which has ported in or ported out in the ENUM and/or ENUM/HSS.

2. An apparatus for synchronizing ported number data within a telecommunications network in which a number portability administration center has received a request from a subscriber having a directory number (DN) to port, the apparatus comprising:
a new NP data manager within a system serving end users, which subscribes to changes in network-level NP data for the LRNs that switch/network owns, on receiving a notification, the NP data manager activates or deactivates local NP data for the Number which has ported in or ported out in the ENUM and/or ENUM/HSS;
a new capability inside existing network NP Databases (NPDB) which honors those subscriptions and, using the methods described above, provides notifications when a number is ported into or out of an LRN to which some switch/network NP data manager has subscribed;
included in this capability is for the NPDB to determine which network to send this to (both for ported in, and ported out);
for a first time port, the NPDB needs to derive the code holder based on the DN and infors the NP Data manager associated with that code holder that this DN is porting out;
for other ports, the NPDB needs to derive (via the LRN in its internal database associated with this DN) the NP data manager for the ‘old’ network and inform that NP data manager this DN is ported out. Also, the NPDB will use the new LRN to derive the NP data manager for the ‘new’ network and inform that NP data manager that this DN is ported in.
